(19) United States
(12) Patent Application Publication
(10) Pub. No.: US 2026/0203118 A1
(43) Pub. Date: Jul. 16, 2026

(54) SYSTEMS AND METHODS OF ENTROPY-AWARE DATA DISTRIBUTION-BASED SHARD OPTIMIZATION FOR DECENTRALIZED DATA SYSTEMS

(71) Applicant: Bank of America Corporation, Charlotte, NC (US)

(72) Inventor: Manikandan Rajaraman, Chennai Tamil Nadu (IN)

(21) Appl. No.: 19/021,419

(22) Filed: Jan. 15, 2025

(51) Int. Cl. G06F 9/50

(52) U.S. Cl. CPC G06F 9/5027

(57) ABSTRACT

Systems and methods for entropy-aware data distribution-based shard optimization for decentralized data systems. The systems and methods may include an Entropy-Based Optimal Data Distribution Evaluation Engine (“EBODDEE”). The systems and methods may include an Entropy-Based Optimal Infrastructure Evaluation Engine (“EBOIEE”). The systems and methods may include a plurality of shards. The plurality of shards may include data. The data may include a data access distribution (“DAD”) and a data access workload (“DAW”). The DAD may include a probability mass function (“PMF”). The EBODDEE may be operable to distribute the DAW among the plurality of shards in a way that optimizes efficiency resources for the system and that uses minimal data movement and optimal network bandwidth. The EBOIEE may be operable to scan a configurable infrastructure space by a grid search to obtain optimal configurations for the PMF.

### FIELD OF TECHNOLOGY

Aspects of the disclosure relate to entropy-aware data distribution-based shard optimization systems and methods. Particularly, aspects of the disclosure relate to entropy-aware data distribution-based shard optimization in decentralized data systems.

### BACKGROUND OF THE DISCLOSURE

An organic increase in digital data volume has led to a wide acceptance and adoption of decentralized data systems. But individual nodes in decentralized data systems are limited by resources, e.g., random access memory (“RAM”), processing and/or computational power (central processing unit (“CPU”) cores), storage (e.g., hard disk) and bandwidth (network and/or internal to the system). All or any of these can employ a sharded database architecture with multiple nodes because data may be too large to contain in a single node.

While many sharding strategies currently exist, these sharding strategies focus on distributing data equally among shards. Data access patterns, however, are seldom uniform for individual data items because probability mass functions (“PMFs”) of data access distributions are often skewed toward a few data items accessed more frequently than others. Therefore, equal distribution of data among shards has an inherent tendency for producing hotspots among shards holding more frequently accessed records. Therefore, data distribution among shards should ideally be determined by data access workloads (e.g., for read or write) rather than data storage workloads.

In a stateful system, such as a database with replicated architecture, an anti-entropy gossip protocol may reduce entropies between replicas. It is necessary to ensure that replicas are in sync with each other to avoid data integrity issues that might creep in because of replication. Techniques such as checksum, recent update list, and Merkle Tree can be used to identify differences between nodes to avoid transmission of entire datasets and reduce network bandwidth usage.

Therefore, it would be desirable to deterministically distribute data so that data access workload for every shard is optimal for PMFs of a given data access distribution and a given infrastructure configuration. It would also be desirable to cater to differences between read-based and write-based data workloads. Additionally, it would be desirable to dynamically re-distribute data in response to changes in data access distribution. And it would be desirable to identify an optimal infrastructure configuration for a given PMF of data access distribution.

It would also be desirable to distribute data based on the principle of equal data access workload across shards instead of equal data storage workload as compared to the current state of sharding. It would be desirable to obtain an optimal data distribution for a given infrastructure and a given data access distribution. It would be desirable to search for an optimal infrastructure for a given data access distribution. Finally, it would be desirable to deal with data distribution across shards in a network rather than synchronization issues amongst replicas.

### SUMMARY OF THE DISCLOSURE

Provided herein are systems and methods for entropy-aware data distribution-based shard optimization for decentralized data systems.

Systems and methods may provide equal data access workloads across shards instead of equal data storage workloads. Systems and methods may divide and/or break down PMFs of data access workloads into exact replicas (or similar replicas) across shards. Processing required by the systems and methods at each physical shard or physical machine holding logical shards may be the same or similar, thus avoiding chances of hotspot development.

Systems and methods may access entropy of data in each shard. Systems and methods may ensure that a variance of entropy across shards is at a minimum (local) for a current infrastructure.

Systems and methods may provide data redistribution in a deterministic, non-probabilistic manner. Current sharding mechanisms are probabilistic including, e.g., hash-based, lookup-based, range-based, etc.

Systems and methods may perform a grid search on a configurable range of infrastructure configurations to obtain a global minimum for variance of the entropy across shards for data access workload PMFs. Systems and methods may dynamically respond to changes in data access distribution PMF and redistribute data across shards.

Systems and methods may ensure additional constraints of minimal data movement. Moreover, systems and method components may be plugged into any existing distributed, sharded data storage system and/or method. Systems and methods may perform in real time or in near real time without impacting on a real time workflow (read or write path).

The systems and methods may include a data distribution engine. The data distribution engine may distribute data access workload as evenly as possible among the shards in any given infrastructure. The data distribution engine may dynamically handle changes in data access workload PMF. The data distribution engine may redistribute data ensuring minimal data movement. The data distribution engine may ensure optimal network bandwidth usage.

The systems and methods may include an infrastructure evaluation engine. The infrastructure evaluation engine may perform a grid search over a range of infrastructure configuration spaces to obtain optimal infrastructure configurations. The infrastructure evaluation engine may obtain PMFs providing shards with exactly equal data access workloads. The infrastructure evaluation engine may provide optimal configuration for this data.

The systems and methods may include an infrastructure evaluation engine. The infrastructure evaluation engine may predict, e.g., service level agreements (“SLAs”) for each of the evaluated infrastructure configurations to enable infrastructure architectures. The infrastructure evaluation engine may predict, e.g., a best return on investment (“ROI”).

The systems and methods may include an entropy-aware data redistribution paradigm. The systems and methods may enable data to be distributed across shards such that they have equal data access workloads. The systems and methods may handle intrinsic differences between read-based and write-based workloads. For example, write workloads block other reads and writes. Further, multiple reads are supported simultaneously while multiple writes are not.

The systems and methods may enable dynamic redistribution of data by responding to the changes in data access distribution PMF. The systems and methods may include an Entropy-Based Optimal Data Distribution Evaluation Engine (“EBODDEE”). The EBODDEE may handle all the above capabilities for a given infrastructure configuration.

The systems and methods may include an Entropy-Based Optimal Infrastructure Evaluation Engine (“EBOIEE”). The EBOIEE may scan across a configurable infrastructure space by way of a grid search to obtain an optimal configuration for the data access distribution PMF.

The EBOIEE may predict SLA parameters, e.g., latency and throughput for any configuration. The EBOIEE may switch from a current infrastructure configuration to an optimal infrastructure configuration for data access distribution PMF. The EBOIEE may predict a best ROI for a given infrastructure. The systems and methods may work with other techniques, e.g., hash-based, lookup-based, and range-based.

The systems and methods may provide entropy-aware data redistribution in a deterministic approach towards arriving at an optimal distribution strategy for a given infrastructure. The systems and methods may handle data access workloads for decentralized data systems.

The systems and methods may account for intrinsic differences in read-and write-based workloads to ensure optimal usage of available computing capabilities of the infrastructure at disposal. The systems and methods may scan over all possible infrastructure configuration spaces, obtaining an optimal infrastructure configuration for a given data access distribution PMF. Additionally, the systems and methods may predict SLA parameters for different configurations.

The systems and methods may obtain local minima for entropy variance of data access distribution PMFs for given infrastructures. The systems and methods may obtain a global minimum for entropy variance of a data access distribution PMF for a given infrastructure by scanning an infrastructure configuration space. The systems and methods may ensure minimal data movement.

The systems and methods may result in minimal network bandwidth usage for a gossip protocol. A gossip protocol is a decentralized peer-to-peer communication method used in distributed systems to disseminate data efficiently in a network. In a gossip protocol, each node in the network may send data to a subset of other nodes, ensuring data reaches all nodes in the network. Gossip protocols may be scalable, fault-tolerant, and may handle dynamic changes in the network.

The systems and methods may result in maximum network bandwidth usage for actual data access workload handling. The systems and methods may dynamically respond to changes in data access distribution PMF.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout.

FIG. 1 shows an illustrative process flow 100 for a system in accordance with principles of the disclosure.

FIG. 2 shows an illustrative diagram 200 for a system in accordance with principles of the disclosure.

FIG. 3 shows an illustrative diagram 300 for a system in accordance with principles of the disclosure.

FIG. 4A shows illustrative charts corresponding to FIG. 2 for a system in accordance with principles of the disclosure.

FIG. 4B shows illustrative charts corresponding to FIG. 3 for a system in accordance with principles of the disclosure.

FIG. 5 shows a schematic diagram 500 in accordance with principles of the disclosure.

FIG. 6 shows another schematic diagram 600 in accordance with principles of the disclosure.

### DETAILED DESCRIPTION OF THE DISCLOSURE

Systems and methods for entropy-aware data distribution-based shard optimization for decentralized data systems are provided.

Systems may include an EBODDEE. Systems may include an EBOIEE. Systems may include a plurality of shards.

Each of the plurality of shards may include data. The data may include a data access distribution (“DAD”). The data may include a data access workload (“DAW”). The DAD may include a PMF.

The EBODDEE may be operable to distribute the DAW among the plurality of shards. The EBODDEE may be operable to distribute the DAW among the plurality of shards in a way that optimizes efficiency resources for the system.

The EBOIEE may be operable to scan a configurable infrastructure by a grid search. The EBOIEE may be operable to scan a configurable infrastructure by a grid search to obtain an optimal configuration for the PMF.

The EBODDEE may be operable to redistribute the DAW among the plurality of shards. The EBODDEE may be operable to redistribute the DAW among the plurality of shards in response to an optimal configuration for the PMF. The EBODDEE may be operable to redistribute the DAW among the plurality of shards in a way that uses minimal data movement and optimal network bandwidth.

The EBODDEE may be operable to handle dynamic changes in the PMF. The EBODDEE may be operable to handle dynamic changes in the PMF by further redistributing the DAW among the plurality of shards. The EBODDEE may be operable to redistribute the DAW among the plurality of shards in response to dynamic changes in the PMF.

The DAW may be redistributed in a way that results in a minimum entropy variance for the DAW. The plurality of shards may be each given equal DAW masses. The equal DAW masses may be derived by the EBOIEE.

The EBODDEE may be operable to obtain an optimal distribution strategy for the configurable infrastructure. The EBODDEE may be operable to redistribute a plurality of DAWs for a decentralized data system. The EBODDEE may be operable to redistribute a plurality of DAWs for a decentralized data system based on an optimal distribution strategy for the configurable infrastructure.

The EBODDEE may be operable to use differences between read-based and write-based DAWs. The EBODDEE may be operable to use differences between read-based and write-based DAWs to optimize usage of available computing capabilities of a given infrastructure.

The EBOIEE may be operable to scan over all possible infrastructure configurations. The EBOIEE may be operable to scan over all possible infrastructure configurations enabling the EBODDEE to arrive at an optimal infrastructure configuration for the PMF.

The EBODDEE may be operable to predict SLA parameters. The EBODDEE may be operable to predict SLA parameters for different DAW configurations.

The EBODDEE may be operable to obtain a local minimum for entropy variance. The EBODDEE may be operable to obtain a local minimum for entropy variance of the PMF. The EBOIEE may be operable to obtain a global minimum for entropy variance of the PMF by scanning an infrastructure configuration space.

The EBODDEE may be operable to minimize use of network bandwidth. The EBODDEE may be operable to minimize use of network bandwidth for a gossip protocol. The EBODDEE may be operable to maximize network bandwidth usage. The EBODDEE may be operable to maximize network bandwidth usage for actual DAW handling.

The EBODDEE may be operable to provide an optimal infrastructure for a plurality of infrastructure architectures. The EBODDEE may be operable to evaluate, via the plurality of infrastructure architectures, the system for budgeting. The EBODDEE may be operable to perform a ROI evaluation. The ROI evaluation may include expenses incurred for a new infrastructure set up. The ROI evaluation may include benefits obtained from improved SLA parameters. The SLA parameters may include parameters, e.g., latency and throughput parameters.

The systems may include the distributing of the DAW among the plurality of shards, the scanning of the configurable infrastructure, the redistributing of the DAW among the plurality of shards, the handling of the dynamic changes in the PMF, the redistributing of the DAW to result in a minimum entropy variance for the DAW, the deriving equal DAW masses for each of the plurality of shards, and the distributing each of the equal DAW masses to the plurality of shards resulting in the data stored in each of the plurality of shards including, e.g., an access probability [p] less than or equal to 1, a surprise quotient [-log2(p)] less than or equal to 3, an expected surprise [-p*log2(p)] less than or equal to 1, an entropy Σ[-p*log 2(p)] less than or equal to 2, and an entropy variance less than or equal to 0.5.

Methods for providing deterministic entropy-aware data distribution-based shard optimization for decentralized data systems are provided.

The methods may include distributing, via an EBODDEE, a DAW among a plurality of shards in a way that optimizes efficiency resources for the system. Methods may include distributing data among a plurality of shards. The data may include a DAD. The data may include the DAW. The DAD may include a PMF.

The methods may include scanning, via an EBOIEE, a configurable infrastructure by a grid search. The scanning may obtain an optimal configuration for the PMF.

The methods may include redistributing, via the EBODDEE, the DAW among the plurality of shards. The redistributing the DAW among the plurality of shards may be in response to an optimal configuration for the PMF. The redistributing the DAW among the plurality of shards may be in a way that uses minimal data movement. The redistributing the DAW among the plurality of shards may be in a way that uses optimal network bandwidth.

The methods may include handling, via the EBODDEE, dynamic changes in the PMF. The methods may include handling, via the EBODDEE, dynamic changes in the PMF by further redistributing the DAW among the plurality of shards. The methods may include handling, via the EBODDEE, dynamic changes in the PMF by further redistributing the DAW among the plurality of shards based on changes in the nature of the PMF.

The methods may include redistributing, via the EBODDEE, the DAW. The methods may include redistributing, via the EBODDEE, the DAW in a way that results in a minimum entropy variance for the DAW.

The methods may include deriving, by the EBOIEE, equal DAW masses for each of the plurality of shards. The methods may include distributing, via the EBODDEE, each of the equal DAW masses to each of the plurality of shards.

The methods may include arriving, via the EBODDEE, at an optimal distribution strategy for the configurable infrastructure. The methods may include redistributing, via the EBODDEE, a plurality of DAWs for a decentralized data system based on an optimal distribution strategy for the configurable infrastructure.

The methods may include using, via the EBODDEE, differences between read-based and write-based DAWs to optimize usage of available computing capabilities of a given infrastructure. The methods may include scanning, via the EBOIEE, over all possible infrastructure configurations. The scanning over all possible infrastructure configurations may enable the EBODDEE to obtain an optimal infrastructure configuration for the PMF.

The methods may include predicting, via the EBODDEE, SLA parameters for different DAW configurations. The methods may include obtaining, via the EBODDEE, a local minimum for entropy variance of the PMF.

The methods may include scanning, via the EBOIEE, an infrastructure configuration space to obtain a global minimum for entropy variance of the PMF. The methods may include minimizing, via the EBODDEE, use of network bandwidth for a gossip protocol and maximizing, via the EBODDEE, network bandwidth for actual DAW handling.

The methods may include providing, via the EBODDEE, an optimal infrastructure for a plurality of infrastructure architectures. The methods may include evaluating the system, via the EBODDEE using a plurality of infrastructure architecture, for budgeting. The methods may include performing, via the EBODDEE, a ROI evaluation. The ROI evaluation may be done for expenses incurred for a new infrastructure set up. The ROI evaluation may be done for benefits obtained from improved SLA parameters. The SLA parameters may include parameters, e.g., latency and throughput parameters.

The methods may include the distributing of the DAW among the plurality of shards, the scanning of the configurable infrastructure, the redistributing of the DAW among the plurality of shards, the handling of the dynamic changes in the PMF, the redistributing of the DAW to result in a minimum entropy variance for the DAW, the deriving equal DAW masses for each of the plurality of shards, and the distributing each of the equal DAW masses to the plurality of shards resulting in the data stored in each of the plurality of shards including, e.g., an access probability [p] less than or equal to 1, a surprise quotient [-log2(p)] less than or equal to 3, an expected surprise [-p*log2(p)] less than or equal to 1, and an entropy variance less than or equal to 0.5.

The systems and methods may include data storage. The data storage may include distributed hash table-based storage. The data storage may include replication and eventual consistency handled by a gossip protocol. The data storage may include a multi-tenant architecture to serve multiple consumers at a time.

The systems and methods may include a data distribution-aware insights layer. The data distribution-aware insights layer may communicate with a sharded distributed storage layer with an enhanced gossip protocol, e.g., enhanced data.

The systems and methods may include an anti-entropy Gossip protocol. The systems and methods may include a data distribution-aware Gossip (“DDAG”) protocol.

The data distribution-aware insights layer may include two sub-components, e.g., an EBODDEE and an EBOIEE.

The EBODDEE may be an entropy-aware data distribution engine that deterministically obtains best possible data distribution among shards. The EBODDEE may arrive at local minima of entropy variance of data access distribution PMF for a current infrastructure. The current infrastructure may be a current cluster configuration in terms of the number of nodes and logical shards.

The EBODDEE may ensure minimum data movement among shards so that maximum network bandwidth is utilized for throughput and is not used for data movement/re-distribution among shards.

The EBODDEE may update a query processing layer to handle the data movement. The exact update may depend on a kind of sharding adopted for distributed data storage implementation, e.g., hash-based or lookup-based. The EBODDEE may provide range-based sharding.

The EBOIEE may deterministically obtain an optimal infrastructure, i.e., a cluster configuration in terms of the number of nodes and logical shards, which may attain global minima for entropy variance of data access distribution PMFs.

The EBODDEE may predict a latency and throughput that can be attained for various infrastructure configurations on its way to obtaining optimal infrastructure for a given data access distribution PMF.

The EBODDEE may provide an optimal infrastructure for infrastructure architectures. The EBODDEE may evaluate budgeting aspects to perform ROI evaluations for expenses incurred for a new infrastructure set up and benefits obtained in terms of improved SLA, e.g., latency and throughput.

Systems and methods described herein are illustrative. Systems and methods in accordance with this disclosure will now be described in connection with the figures, which form a part hereof. The figures show illustrative features of system and method steps in accordance with the principles of this disclosure. It is understood that other embodiments may be utilized, and that structural, functional, and procedural modifications may be made without departing from the scope and spirit of the present disclosure.

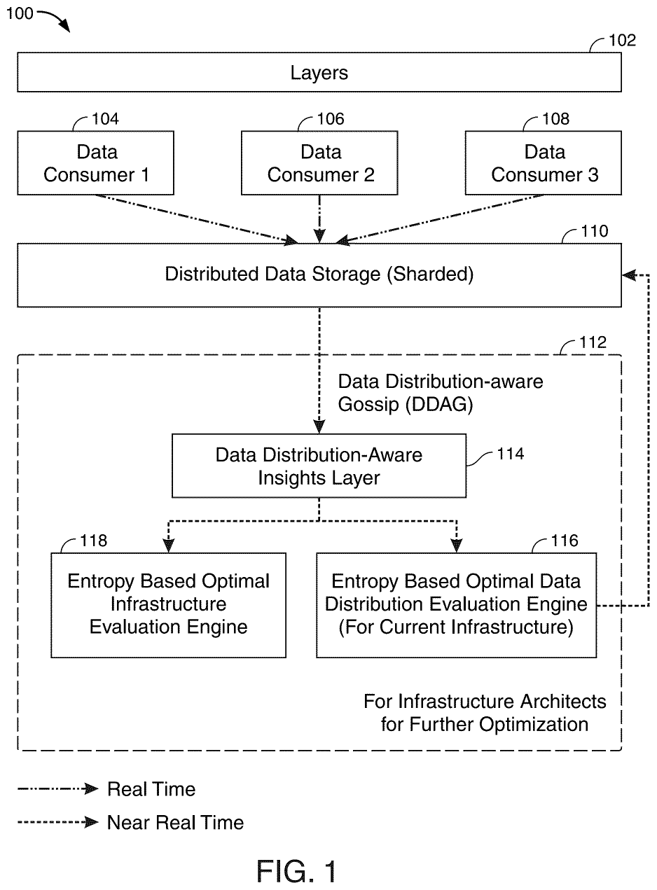

FIG. 1 shows an illustrative process flow 100 for a system in accordance with principles of the disclosure.

Illustrative process flow 100 may include layers 102. The layers 102 may include, e.g., a data consumer layer, a distributed data storage layer, and a DDAG layer 112. The layers 102 may communicate with one another in real time and/or in near real time.

Near real time may be, e.g., approximately real time or real time ±1 second, 5 seconds, 10 seconds, 1 minute, 5 minutes, 10 minutes, etc.

The data consumer layer may include, e.g., data consumer 1, 104, data consumer 2, 106, and data consumer 3, 108. Data in the distributed data storage layer may be sharded. The distributed data storage layer may be, e.g., a distributed data storage (sharded) 110.

The DDAG layer 112 may include, e.g., a data distribution-aware insights layer 114, an entropy-based optimal data distribution evaluation engine (for current infrastructure) 116, and an entropy-based optimal infrastructure evaluation engine 118. The entropy-based optimal infrastructure evaluation engine 118 may be for infrastructure architects and/or architectures for further optimization.

The data consumer layer, e.g., data consumer 1, 104, data consumer 2, 106, and data consumer 3, 108, may send data to the distributed data storage layer (sharded) 110. The data may be sent in real time.

The distributed data storage layer (sharded) 110 may send data to the data distribution-aware insights layer 114 in the DDAG layer 112. The data may be sent in near real time.

The data distribution-aware insights layer 114 in the DDAG layer 112 may send data to the entropy-based optimal data distribution evaluation engine (for current infrastructure) 116 and/or the entropy-based optimal infrastructure evaluation engine 118. The data may be sent in near real time.

The entropy-based optimal data distribution evaluation engine (for current infrastructure) 116 may send data back to the distributed data storage layer (sharded) 110. The data may be sent in near real time.

Entropy-based optimal data distribution evaluation engines may redistribute data by moving data points in a way that ensures that the data access distributions in the shards are the same. Therefore, entropy-based optimal data distribution evaluation engines may ensure optimal use of current infrastructure.

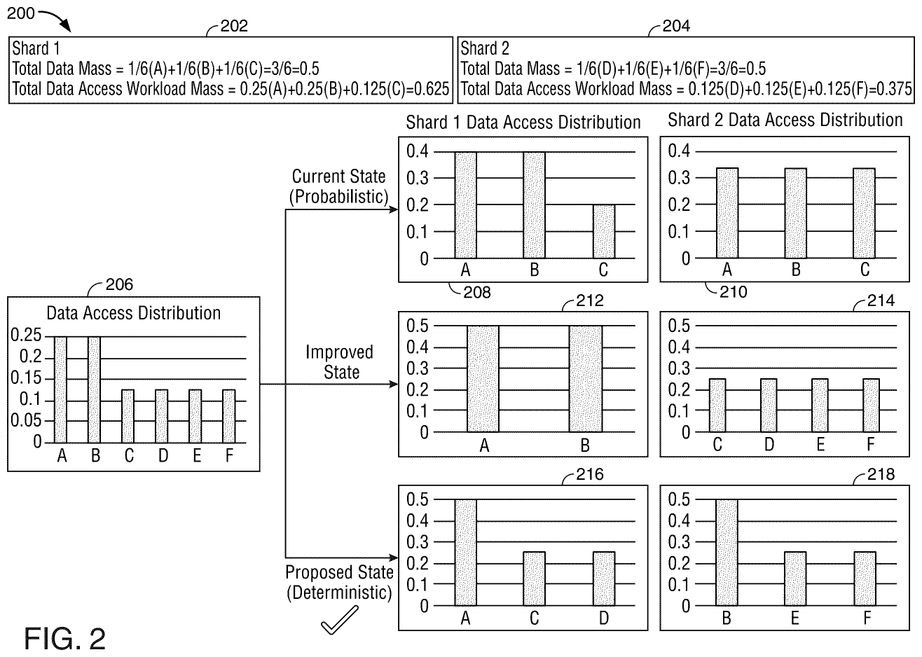

FIG. 2 shows an illustrative diagram 200 for a system in accordance with principles of the disclosure.

The illustrative diagram 200 may include shard 1, 202. Shard 1, 202 may include a mathematical equation describing total data mass of shard 1, 202. For example, total data mass of shard 1, 202 may equal ⅙(A)+⅙(B)+⅙(C)= 3/6=0.5. Shard 1, 202 may include a mathematical equation describing total data access workload mass of shard 1, 202. For example, total data access workload mass of shard 1, 202 may equal 0.25(A)+0.25(B)+0.125(C)=0.625.

The illustrative diagram 200 may include shard 2, 204. Shard 2, 204 may include a mathematical equation describing total data mass of shard 2, 204. For example, total data mass of shard 2, 204 may equal ⅙(D)+⅙(E)+⅙(F)= 3/6=0.5. Shard 2, 204 may include a mathematical equation describing total data access workload mass of shard 2, 204. For example, total data access workload mass of shard 2, 204 may equal 0.125(D)+0.125(E)+0.125(F)=0.375.

The illustrative diagram 200 may include data access distribution 206. Data access distribution 206 may be represented by a data access distribution chart. The data access distribution chart may show, e.g., A=0.25, B=0.25, C=0.125, D=0.125, E=0.125, and F=0.125.

Data access distributions for shard 1, 202 may be represented by, e.g., shard 1 data access distribution, current state (probabilistic) 208, shard 1 data access distribution, improved state 212, and shard 1 data access distribution, proposed state (deterministic) 216. Shard 1 data access distribution, current state (probabilistic) 208 may show that A=0.4, B=0.4, and C=0.2. Shard 1 data access distribution, improved state 212 may show that A=0.5 and B=0.5. Shard 1 data access distribution, proposed state (deterministic) 216 may show that A=0.5, C=0.25, and D=0.25.

Data access distributions for shard 2, 204 may be represented by, e.g., shard 2, 204 data access distribution, current state (probabilistic) 210, shard 2 data access distribution, improved state 214, and shard 2 data access distribution, proposed state (deterministic) 218. Shard 2 data access distribution, current state (probabilistic) 210, may show that A=⅓, B=⅓, and C=⅓. Shard 2 data access distribution, improved state 214, may show that C=0.25, D=0.25, E=0.25, and F=0.25. Shard 2 data access distribution, proposed state (deterministic) 418 may show that B=0.5, E=0.25, and F=0.25.

Thus, entropy-based optimal data distribution evaluation engines may redistribute data entropically by moving data points in a way that ensures that the data access distributions in the shards are the same. Therefore, entropy-based optimal data distribution evaluation engines may ensure optimal use of current infrastructure in a deterministic, non-probabilistic way.

Three possible data distributions are provided: distribution 1 (current state), distribution 2 (improvement on current state), and distribution 3 (proposed state).

Distribution 1 (current state) may provide equal distribution of data mass/items. Shard 1 data access workload mass of 0.625 is much higher than that of Shard 2 which 0.325. Hence, Shard 1 would quickly turn into a hotspot.

Distribution 2 (improvement on current state) may provide equal distribution of data access workload. Shard 1 and Shard 2 have equal data access workload mass of 0.5. Note that data read and write workloads are inherently different in nature. In a scenario where A and B are in the same shard, consider a case where four requests for A and B land in Shard 1 of which one is a read request, and another one is a write request, for each of A and B. During the same time, consider four requests, one each for C, D, E, and F, that land in Shard 2 of which requests for C and D are read requests and E and F are write requests. Thus, while serving write requests for A and B, corresponding records may be locked and, therefore, read requests may also be blocked and kept waiting until write requests finish. Hence, during that time, Shard 1 may only handle two requests, and the other two requests may be blocked.

Distribution 3 (proposed state) may provide equal distribution of data access workload with least entropy variance. Shard 1 and Shard 2 have equal data access workload mass of 0.5. Additionally, the systems and methods may ensure that the variance of the entropy of the data in Shards 1 and 2 is as minimal as possible, i.e., 0 in this case.

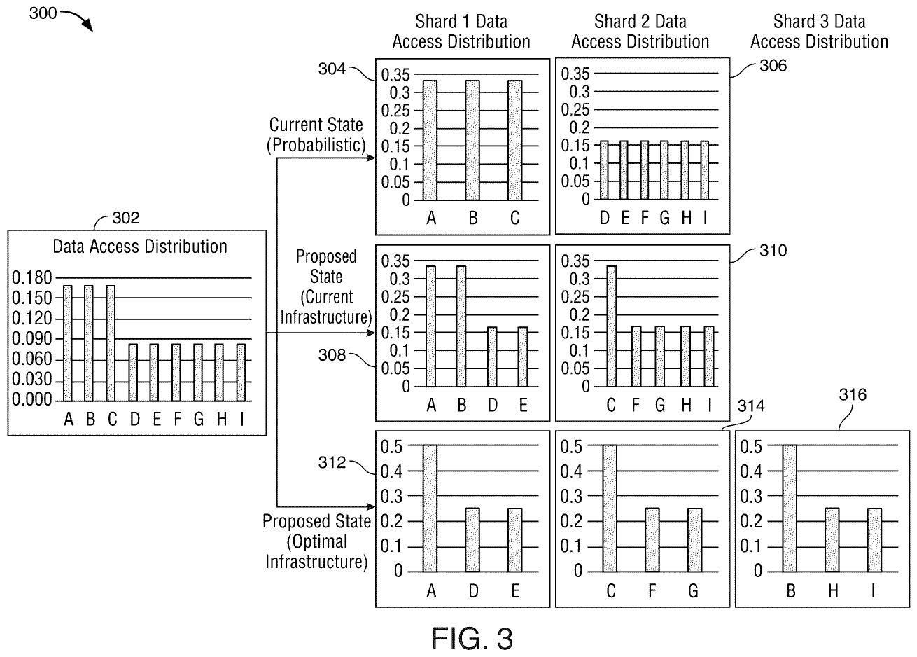

FIG. 3 shows an illustrative diagram 300 for a system in accordance with principles of the disclosure.

The illustrative diagram 300 may include shard 1. Shard 1 may include a mathematical equation describing total data mass of shard 1. For example, total data mass of shard 1 may equal 1/9(A)+ 1/9(D)+ 1/9(E)= 3/9=0.333. Shard 1 may include a mathematical equation describing total data access workload mass of shard 1. For example, total data access workload mass of shard 1 may equal 2/12(A)+ 1/12(D)+ 1/12(E)=0.333333.

The illustrative diagram 300 may include shard 2. Shard 2 may include a mathematical equation describing total data mass of shard 2. For example, total data mass of shard 2 may equal 1/9(C)+ 1/9(F)+ 1/9(G)= 3/9=0.333. Shard 2 may include a mathematical equation describing total data access workload mass of shard 2. For example, total data access workload mass of shard 2 may equal 2/12(C)+ 1/12(F)+ 1/12(G)=0.333333.

The illustrative diagram 300 may include shard 3. Shard 3 may include a mathematical equation describing total data mass of shard 3. For example, total data mass of shard 3 may equal 1/9(B)+ 1/9(H)+ 1/9(I)= 3/9=0.333. Shard 3 may include a mathematical equation describing total data access workload mass of shard 3. For example, total data access workload mass of shard 3 may equal 2/12(B)+ 1/12(H)+ 1/12(I)=0.333333.

The illustrative diagram 300 may include data access distribution 302. Data access distribution 302 may be represented by a data access distribution chart. The data access distribution chart may show, e.g., A=0.175, B=0.175, C=0.175, D=0.75, E=0.75, F=0.75, G=0.75, H=0.75, and I=0.75.

Data access distributions for shard 1 may be represented by, e.g., shard 1 data access distribution, current state (probabilistic) 304, shard 1 data access distribution, proposed state (current infrastructure) 308, and shard 1 data access distribution, proposed state (optimal infrastructure) 312. Shard 1 data access distribution, current state (probabilistic) 304 may show that A=0.333, B=0.333, and C=0.333. Shard 1 data access distribution, proposed state (current infrastructure) 308 may show that A=0.333, B=0.333, D=0.167, and E=0.167. Shard 1 data access distribution, proposed state (optimal infrastructure) 312 may show that A=0.5, D=0.25, and E=0.25.

Data access distributions for shard 2 may be represented by, e.g., shard 2 data access distribution, current state (probabilistic) 306, shard 2 data access distribution, proposed state (current infrastructure) 310, and shard 2 data access distribution, proposed state (optimal infrastructure) 314. Shard 2 data access distribution, current state (probabilistic) 306, may show that D=0.167, E=0.167, F=0.167, G=0.167, H=0.167, and I=0.167. Shard 2 data access distribution, proposed state (current infrastructure) 310 may show that C=0.333, F=0.167, G=0.167, H=0.167, and F=0.167. Thus, the engine performing grid search may enable the systems and methods to obtain an optimal infrastructure configuration for two shards. Shard 2 data access distribution, proposed state (optimal infrastructure) 314 may show that C=0.5, F=0.25, and G=0.25.

Data access distributions for shard 3 may be represented by, e.g., shard 3 data access distribution (optimal infrastructure) 316. Shard 3 data access distribution (optimal infrastructure) 316 may show that B=0.5, H=0.25, and I=0.25. Thus, the engine performing grid search may enable the systems and methods to obtain an optimal infrastructure configuration for three shards.

Thus, entropy-based optimal data distribution evaluation engines may redistribute data entropically by moving data points in a way that ensures that the data access distributions in the shards are the same. Therefore, entropy-based optimal data distribution evaluation engines may ensure optimal use of current infrastructure in a deterministic, non-probabilistic way.

An engine performing grid search may enable the systems and methods to obtain an optimal infrastructure configuration for, e.g., data access distribution for two shards, three shards, etc. Therefore, the systems and methods may obtain globally optimal infrastructure configurations by ensuring that data access distributions across shards is the same.

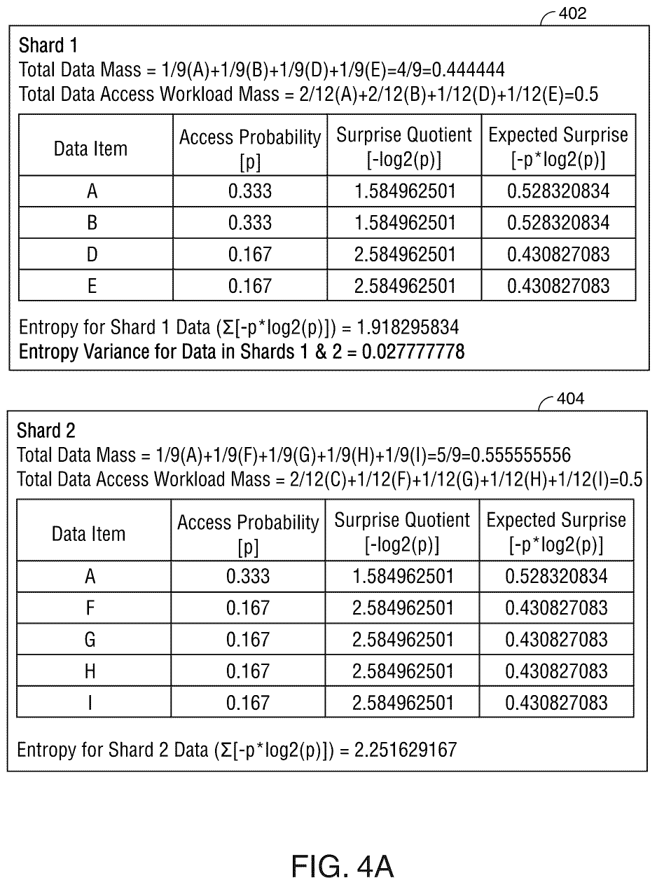

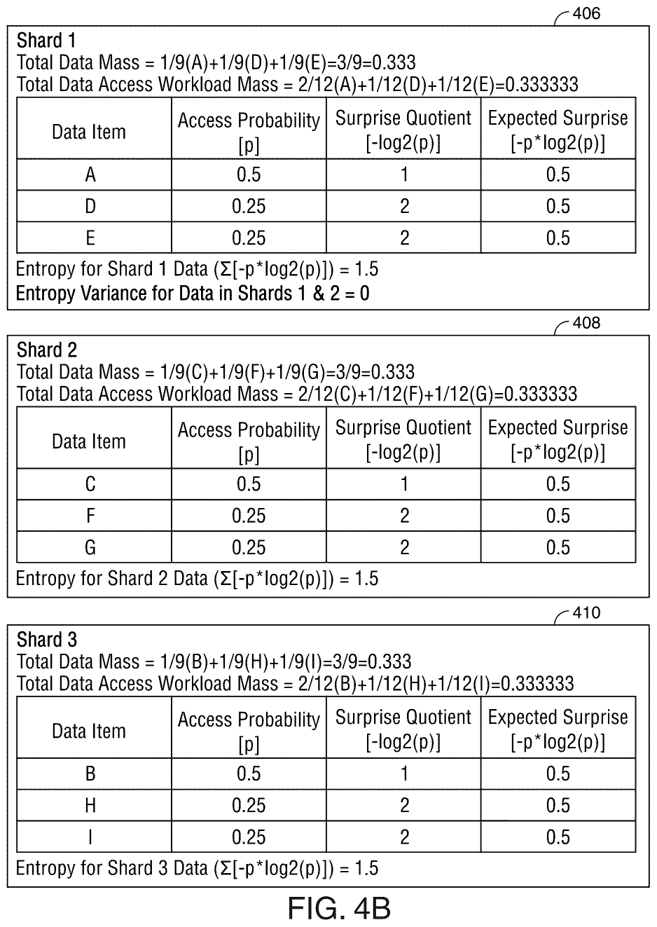

FIG. 4A shows illustrative charts corresponding to FIG. 2 for a system in accordance with principles of the disclosure.

FIG. 4A illustrative charts show data within shard 1, 402. Shard 1, 402 may be described by a mathematical equation describing total data mass of shard 1, 402. For example, total data mass of shard 1, 402 may equal 1/9(A)+ 1/9(B)+ 1/9(D)+ 1/9(E)= 4/9=0.444444. Shard 1, 402 may be described by a mathematical equation describing total data access workload mass of shard 1, 402. For example, total data access workload mass of shard 1, 406 may equal 2/12(A)+ 2/12(B)+ 1/12(D)+ 1/12(E)=0.5.

Access probability [p] for shard 1, 402 is: A=0.333, B=0.333, D=0.167, and E=0.167. Surprise quotient [-log2(p)] for shard 1, 402 is: A=1.584962501, B=1.584962501, D=2.584962501, and E=2.584962501. Expected surprise [-p*log2(p)] for shard 1, 402 is: A=0.528320834, B=0.528320834, D=0.430827083, and E=0.430827083. Entropy for shard 1, 402 data Σ[-p*log2(p)]=1.918295834. In this case, entropy variance for data in shard 1, 402 is 0.027777778.

FIG. 4A illustrative charts show data within shard 2, 404. Shard 2, 404 may be described by a mathematical equation describing total data mass of shard 2, 404. For example, total data mass of shard 2, 404 may equal 1/9(C)+ 1/9(F)+ 1/9(G)+ 1/9(H)+ 1/9(I)= 5/9=0.555555556. Shard 2, 404 may be described by a mathematical equation describing total data access workload mass of shard 2, 404. For example, total data access workload mass of shard 2, 404 may equal 2/12(C)+ 1/12(F)+ 1/12(G)+ 1/12(H)+ 1/12(I)=0.5.

Access probability [p] for shard 2, 404 is: C=0.333, F=0.167, G=0.167, H=0.167, and I=0.167. Surprise quotient [-log2(p)] for shard 2, 404 is: C=1.584962501, F=2.584962501, G=2.584962501, H=2.584962501, and I=2.584962501. Expected surprise [-p*log2(p)] for shard 2, 404 is: C=0.528320834, F=0.430827083, G=0.430827083, H=0.430827083, and I=0.430827083. Entropy for shard 2, 404 data Σ[-p*log2(p)] =2.251629167.

FIG. 4B shows illustrative charts corresponding to FIG. 3 for a system in accordance with principles of the disclosure.

FIG. 4B illustrative charts show data within shard 1, 406. Shard 1, 406 may be described by a mathematical equation describing total data mass of shard 1, 406. For example, total data mass of shard 1, 406 may equal 1/9(A)+ 1/9(D)+ 1/9(E)= 3/9=0.333. Shard 1, 406 may be described by a mathematical equation describing total data access workload mass of shard 1, 406. For example, total data access workload mass of shard 1, 406 may equal 2/12(A)+ 1/12(D)+ 1/12(E)=0.333333.

Access probability [p] for shard 1, 406 is: A=0.5, D=0.25, and E=0.25. Surprise quotient [-log2(p)] for shard 1, 406 is: A=1, D=2, and E=2. Expected surprise [-p*log2(p)] for shard 1, 406 is: A=0.5, D=0.5, and E=0.5. Entropy for shard 1, 406 data Σ[-p*log2(p)]=1.5. In this case, entropy variance for data in shard 1, 406 is 0.

FIG. 4B illustrative charts show data within shard 2, 408. Shard 2, 408 may be described by a mathematical equation describing total data mass of shard 2, 408. For example, total data mass of shard 2, 408 may equal 1/9(C)+ 1/9(F)+ 1/9(G)= 3/9=0.333. Shard 2, 408 may be described by a mathematical equation describing total data access workload mass of shard 2, 408. For example, total data access workload mass of shard 2, 408 may equal 2/12(C)+ 1/12(F)+ 1/12(G)=0.333333.

Access probability [p] for shard 2, 408 is: C=0.5, F=0.25, and G=0.25. Surprise quotient [-log 2(p)] for shard 2, 408 is: C=1, F=2, and G=2. Expected surprise [-p*log2(p)] for shard 2, 408 is: C=0.5, F=0.5, and G=0.5. Entropy for shard 2, 408 data Σ[-p*log2(p)]=1.5. In this case, entropy variance for data in shard 2, 408 is 0.

FIG. 4B illustrative charts show data within shard 3, 410. Shard 3, 410 may be described by a mathematical equation describing total data mass of shard 3, 410. For example, total data mass of shard 3, 410 may equal 1/9(B)+ 1/9(H)+ 1/9(I)= 3/9=0.333. Shard 3, 410 may be described by a mathematical equation describing total data access workload mass of shard 3. For example, total data access workload mass of shard 3, 410 may equal 2/12(B)+ 5/12(H)+ 1/12(I)=0.333333.

Access probability [p] for shard 3, 410 is: B=0.5, H=0.25, and I=0.25. Surprise quotient [-log2(p)] for shard 3, 410 is: B=1, H=2, and I=2. Expected surprise [-p*log2(p)] for shard 3, 410 is: B=0.5, H=0.5, and I=0.5. Entropy for shard 3, 410 data >[-p*log2(p)]=1.5. In this case, entropy variance for data in shard 3, 410 is 0.

Note that this is not a probabilistic method but a deterministic method where data is distributed in such a way that the variance in entropy among the shards is minimized.

The total number of ways in which A, B, C, D, E, and F can be distributed among two shards each having data access mass of 0.5 and A and B in different shards is 2*4C2=12. So, out of the 12 combinations, the one to choose would depend on the combination which ensures minimum data movement among shards.

Consider the same scenario where there are 6 data items, namely, A, B, C, D, E, and F where A and B are accessed twice as much as the other items. Hence, DAD PMF is A: 0.25, B: 0.25, C: 0.125, D: 0.125, E: 0.125, and F: 0.125. So, out of every 1000 requests, A and B will be requested 250 times each while C, D, E, and F will be requested 125 times each approximately.

Hence, considering that there are 6 data items, the systems and methods may distribute data items to each of the shards such that the data access mass is distributed equally among the shards, i.e., each shard gets 500 requests. The systems and methods may ensure that the PMF of the data access distribution among the shards is as similar as possible by way of reducing the entropy variance of the data in the shards.

To ensure this, A and B are always placed in different shards. For, e.g., A, C, and D are placed in Shard 1 and B, E, and F are in Shard 2. Hence, out of every 1000 requests, approximately 500 requests for A, C, and D and 500 requests for B, E, and F will be served by Shard 1 and Shard 2, respectively.

The EBODDEE may ensure that data access workload for every shard is optimal for a current PMF of data access distribution for a current infrastructure configuration. This is ensured deterministically by reducing the variance in entropy of the PMF of the data access distribution among the shards. The EBODDEE may also ensure optimal usage of resources of machines holding the shards considering differences between data read-based and write-based workloads. Once the data is redistributed, the EBODDEE may update the query processing layer so that a data fetch happens seamlessly for redistributed data. The exact update may depend on a type of sharding implementation.

Distribution 3 (Proposed State) may provide an equal distribution of data access workload with least entropy variance. Consider a scenario where A, B & C were initially placed in the Shard 1 as per current state distribution illustration in Slide 5. With the proposed state improvement, only B would be moved to Shard 2 while only D might be moved to Shard 1. So, the redistributed data configuration would be A, C & D in Shard 1 while B, E & F in Shard 2. This ensures minimum data movement among shards so that maximum network bandwidth is utilized for throughput and not in data movement.

The benefits of minimum data movement would be more evident when there are more data points which are candidate for movement across shards. Let us consider a case where four requests land up in Shard 1 which are one read and one write request for A, one write request for C and one read request for D. Similarly, four requests land up in Shard 2 which are one read and one write request for B, 1 write request for E and one read request for F. So, while serving write request for A, the corresponding record is locked and hence, the read request is also blocked and kept waiting until write request finishes. At the same time, the requests for C & D are served by Shard 1. Hence, during that time, Shard 1 serves 3 requests while one is blocked and Shard 2 serves three requests while one is blocked. This is optimal usage of the resources available in machines having Shard 1 and Shard 2.

Note that the read request for A in Shard 1 will have to wait until the write request finishes. The read request for B in Shard 2 would also have to wait until the write request finishes.

Thus, the EBODDEE for shard optimization ensures a deterministic approach to identify the best data distribution for current infrastructure configuration, ensures minimal data movement among shards, and updates query processing layers to handle data movement. The exact update may depend on a kind of sharding adopted for distributed data storage implementation, e.g., hash based, lookup based, etc. This may be done by adding a layer of lookup for the moved data as part of entropy variance minimization.

For range-based sharding, instead of minimizing the entropy variance of individual items/points, different ranges of the data point may be considered as a block and the entropy variance may be minimized for the data blocks.

The EBOIEE may evaluate various infrastructure configurations to deterministically arrive at the optimal infrastructure which may obtain global minima for the entropy variance of the data access distribution PMF and hence, an optimal infrastructure configuration to host this data considering the aspects of data access distribution and differences between read and write access. The EBOIEE may assess SLAs in terms of latency and throughput for a current infrastructure and predict corresponding values for an optimal infrastructure proposed for which the global minima for the entropy variance of the data access distribution PMF were obtained.

SLA prediction may be performed for all infrastructure combinations in path from a current to an optimal infrastructure. These details may be handed over to infrastructure architects to evaluate which point (infrastructure or SLA) gives the best infrastructure architecture.

Hence, considering that there are nine data items with the given data access distribution PMF, the EBOIEE may deterministically arrive at an optimal configuration to distribute data items by obtaining the infrastructure combination for which the entropy variance of the data access distribution PMF is at a global minimum, i.e., 0.

The EBOIEE may obtain global minima for entropy variance for data access distribution PMF with a three-shard configuration.

Additionally, consider moving from a current configuration of two shards to a three-shard configuration. The systems and methods may ensure minimum data movement. Such a scenario would only be three data items being moved, namely, B from Shard 1 to Shard 3 and H & I from Shard 2 to Shard 3.

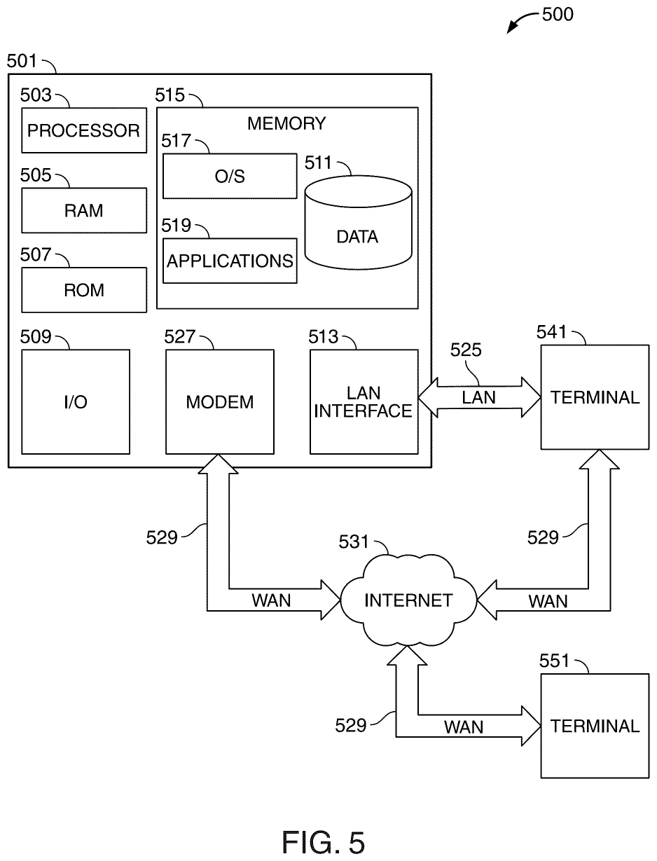

FIG. 5 shows an illustrative block diagram of system 500 that includes computer 501. Computer 501 may alternatively be referred to herein as an “engine,” “server,” or a “computing device.” Computer 501 may be a workstation, desktop, laptop, tablet, smartphone, or any other suitable computing device. Elements of system 500, including computer 501, may be used to implement various aspects of the systems and methods disclosed herein. Each of the systems, methods and algorithms illustrated below may include some or all of the elements and apparatus of system 500.

Computer 501 may include processor 503 for controlling the operation of the device and its associated components, and may include RAM 505, ROM 507, input/output (“I/O”) 509, and a non-transitory or non-volatile memory 515. Machine-readable memory may be configured to store information in machine-readable data structures. Processor 503 may also execute all software running on the computer. Other components commonly used for computers, such as EEPROM or flash memory or any other suitable components, may also be part of computer 501.

Memory 515 may include any suitable permanent storage technology, such as a hard drive. Memory 515 may store software including the operating system 517 and application program(s) 519 along with any data 511 needed for the operation of the system 500. Memory 515 may also store videos, text, and/or audio assistance files. The data stored in memory 515 may also be stored in cache memory, or any other suitable memory.

I/O module 509 may include connectivity to a microphone, keyboard, touch screen, mouse, and/or stylus through which input may be provided into computer 501. The input may include input relating to cursor movement. The input/output module may also include one or more speakers for providing audio output and a video display device for providing textual, audio, audiovisual, and/or graphical output. The input and output may be related to computer application functionality.

System 500 may be connected to other systems via a local area network (“LAN”) interface 513. System 500 may operate in a networked environment supporting connections to one or more remote computers, such as terminals 541 and 551. Terminals 541 and 551 may be personal computers or servers that include many or all of the elements described above relative to system 500. The network connections depicted in FIG. 5 include a LAN 525 and a wide area network (“WAN”) 529 but may also include other networks. When used in a LAN networking environment, computer 501 may connect to LAN 525 through LAN interface 513 or an adapter. When used in a WAN networking environment, computer 501 may include modem 527 or other means for establishing communications over WAN 529, such as Internet 531.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or API. Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 519, which may be used by computer 501, may include computer executable instructions for invoking functionality related to communication, such as e-mail, Short Message Service (“SMS”), and voice input and speech recognition applications. Application program(s) 519 (which may be alternatively referred to herein as “plugins,” “applications,” or “apps”) may include computer executable instructions for invoking functionality related to performing various tasks. Application program(s) 519 may utilize one or more algorithms that process received executable instructions, perform power management routines or other suitable tasks.

The invention may be described in the context of computer-executable instructions, such as application(s) 519, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 501 and/or terminals 541 and 551 may also include various other components, such as a battery, speaker, and/or antennas (not shown). Components of computer system 501 may be linked by a system bus, wirelessly or by other suitable interconnections. Components of computer system 501 may be present on one or more circuit boards. In some embodiments, the components may be integrated into a single chip. The chip may be silicon-based.

Terminal 541 and/or terminal 551 may be portable devices such as a laptop, cell phone, tablet, smartphone, or any other computing system for receiving, storing, transmitting and/or displaying relevant information. Terminal 541 and/or terminal 551 may be one or more user devices. Terminals 541 and 551 may be identical to system 500 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

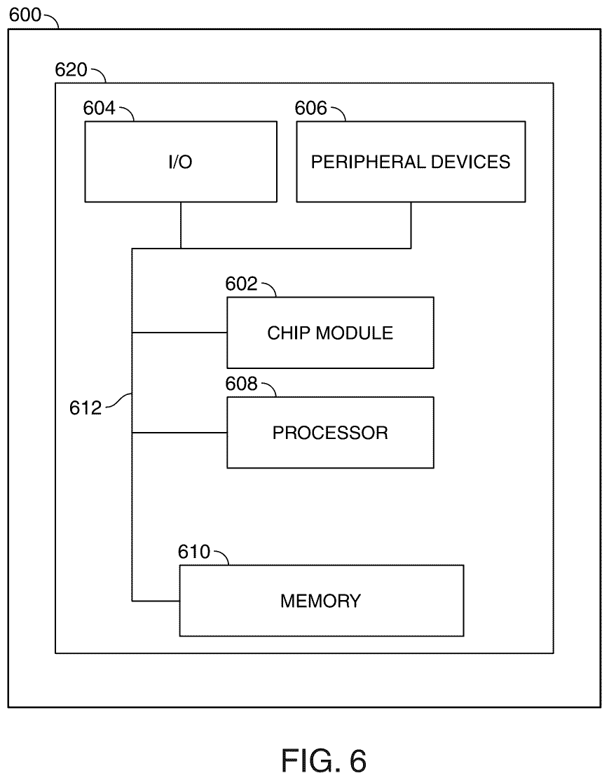

FIG. 6 shows illustrative apparatus 600 that may be configured in accordance with the principles of the disclosure. Apparatus 600 may be a computing device. Apparatus 600 may include one or more features of the apparatus shown in FIG. 5. Apparatus 600 may include chip module 602, which may include one or more integrated circuits, and which may include logic configured to perform any suitable logical operations.

Apparatus 600 may include one or more of the following components: I/O circuitry 604, which may include a transmitter device and a receiver device and may interface with fiber optic cable, coaxial cable, telephone lines, wireless devices, PHY layer hardware, a keypad/display control device or any other suitable media or devices; peripheral devices 606, which may include counter timers, real-time timers, power-on reset generators or any other suitable peripheral devices; logical processing device 608, which may compute data structural information and structural parameters of the data; and machine-readable memory 610.

Machine-readable memory 610 may be configured to store in machine-readable data structures: machine executable instructions, (which may be alternatively referred to herein as “computer instructions” or “computer code”), applications such as applications 619, signals, and/or any other suitable information or data structures.

Components 602, 604, 606, 608, and 610 may be coupled together by a system bus or other interconnections 612 and may be present on one or more circuit boards such as circuit board 620. In some embodiments, the components may be integrated into a single chip. The chip may be silicon-based.

The disclosure may be operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, etc., that perform tasks or implement abstract data types. The disclosure may also be practiced in distributed computing environments where tasks are performed by remote processing devices that are linked through a communications network. In a distributed computing environment, program modules may be in both local and remote computer storage media including memory storage devices.

The steps of methods and systems may be performed in orders beyond the order shown and/or described herein. Embodiments may omit steps shown and/or described in connection with illustrative methods. Embodiments may include steps that are neither shown nor described in connection with illustrative methods.

Illustrative methods and systems steps may be combined. For example, an illustrative method may include steps shown in connection with another illustrative method.

Methods and systems may omit features shown and/or described in connection with illustrative methods and systems. Embodiments may include features that are neither shown nor described in connection with the illustrative methods and systems. Features of illustrative methods and systems may be combined. For example, an illustrative embodiment may include features shown in connection with another illustrative embodiment.

The drawings show illustrative features of methods and systems in accordance with the principles of the disclosure. The features are illustrated in the context of selected embodiments. It will be understood that features shown in connection with one of the embodiments may be practiced in accordance with the principles of the disclosure along with features shown in connection with another of the embodiments.

One of ordinary skill in the art will appreciate that the steps shown and described herein may be performed in other ways and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for providing deterministic entropy-aware data distribution-based shard optimization for decentralized data systems are provided. Persons skilled in the art will appreciate that the present disclosure can be practiced in other ways. The described embodiments are presented for purposes of illustration-not limitation-and the present disclosure is limited only by the claims that follow.

What is claimed is:

1. A system for providing deterministic entropy-aware data distribution-based shard optimization for decentralized data systems, the system comprising:
an Entropy-Based Optimal Data Distribution Evaluation Engine (“EBODDEE”);
an Entropy-Based Optimal Infrastructure Evaluation Engine (“EBOIEE”); and
a plurality of shards, each of the plurality of shards storing data, the data comprising a data access distribution (“DAD”) and a data access workload (“DAW”), the DAD comprising a probability mass function (“PMF”);
wherein:
the EBODDEE is operable to:
distribute the DAW among the plurality of shards to optimize efficiency resources for the system;
the EBOIEE is operable to:
scan a configurable infrastructure by a grid search to obtain an optimal configuration for the PMF; and
the EBODDEE is further operable to:
redistribute the DAW among the plurality of shards, in response to an optimal configuration for the PMF, using minimal data movement and optimal network bandwidth; and
handle dynamic changes in the PMF by further redistributing the DAW among the plurality of shards in response to dynamic changes in the PMF;
wherein:
the DAW is redistributed to result in a minimum entropy variance for the DAW; and
the plurality of shards are each given equal DAW masses, whereby the equal DAW masses are derived by the EBOIEE;
and further wherein the distributing of the DAW among the plurality of shards, the scanning of the configurable infrastructure, the redistributing of the DAW among the plurality of shards, the handling of the dynamic changes in the PMF, the redistributing of the DAW to result in a minimum entropy variance for the DAW, and the giving of the plurality of shards the equal DAW masses results in the data stored in each of the plurality of shards comprising:
an access probability [p] less than or equal to 1;
a surprise quotient [-log2(p)] less than or equal to 3;
an expected surprise [-p*log2(p)] less than or equal to 1;
an entropy Σ[-p*log2(p)] less than or equal to 2; and
an entropy variance less than or equal to 0.5.

2. The system of claim 1, wherein the EBODDEE is further operable to:
obtain an optimal distribution strategy for the configurable infrastructure; and
redistribute a plurality of DAWs for a decentralized data system based on an optimal distribution strategy for the configurable infrastructure.

3. The system of claim 1, wherein the EBODDEE is further operable to use differences between read-based and write-based DAWs to optimize usage of available computing capabilities of a given infrastructure.

4. The system of claim 1, wherein the EBOIEE is further operable to scan over all possible infrastructure configurations, thereby enabling the EBODDEE to arrive at an optimal infrastructure configuration for the PMF.

5. The system of claim 1, wherein the EBODDEE is further operable to predict service level agreement (“SLA”) parameters for different DAW configurations.

6. The system of claim 1, wherein the EBODDEE is further operable to obtain a local minimum for entropy variance of the PMF.

7. The system of claim 1, wherein the EBOIEE is further operable to obtain a global minimum for entropy variance of the PMF by scanning an infrastructure configuration space.

8. The system of claim 1, wherein the EBODDEE is further operable to minimize use of network bandwidth for a gossip protocol and maximize network bandwidth usage for actual DAW handling.

9. The system of claim 1, wherein the EBODDEE is further operable to:
provide an optimal infrastructure for a plurality of infrastructure architectures;
evaluate, via the plurality of infrastructure architectures, the system for budgeting; and
perform a return on investment (“ROI”) evaluation for:
expenses incurred for a new infrastructure set up; and
benefits obtained from improved service level agreement (“SLA”) parameters.

10. The system of claim 9, wherein the SLA parameters comprise latency and throughput parameters.

11. A method for providing deterministic entropy-aware data distribution-based shard optimization for decentralized data systems, the method comprising:
distributing, via an Entropy-Based Optimal Data Distribution Evaluation Engine (“EBODDEE”), a data access workload (“DAW”) among a plurality of shards to optimize efficiency resources for the decentralized data systems, each of the plurality of shards storing data, the data comprising a data access distribution (“DAD”) and the DAW, the DAD comprising a probability mass function (“PMF”);
scanning, via an Entropy-Based Optimal Infrastructure Evaluation Engine (“EBOIEE”), a configurable infrastructure by a grid search to obtain an optimal configuration for the PMF; and
redistributing, via the EBODDEE, the DAW among the plurality of shards, in response to an optimal configuration for the PMF, using minimal data movement and optimal network bandwidth;
handling, via the EBODDEE, dynamic changes in the PMF by further redistributing the DAW among the plurality of shards based on changes in the PMF;
redistributing, via the EBODDEE, the DAW to result in a minimum entropy variance for the DAW;
deriving, by the EBOIEE, equal DAW masses for each of the plurality of shards; and
distributing, via the EBODDEE, each of the equal DAW masses to each of the plurality of shards;
and wherein the distributing of the DAW among the plurality of shards, the scanning of the configurable infrastructure, the redistributing of the DAW among the plurality of shards, the handling of the dynamic changes in the PMF, the redistributing of the DAW to result in a minimum entropy variance for the DAW, the deriving equal DAW masses for each of the plurality of shards, and the distributing each of the equal DAW masses to the plurality of shards results in the data stored in each of the plurality of shards comprising:
an access probability [p] less than or equal to 1;
a surprise quotient [-log2(p)] less than or equal to 3;
an expected surprise [-p*log2(p)] less than or equal to 1;
an entropy Σ[-p*log2(p)] less than or equal to 2; and
an entropy variance less than or equal to 0.5.

12. The method of claim 11, wherein the method further comprises:
arriving, via the EBODDEE, at an optimal distribution strategy for the configurable infrastructure; and
redistributing, via the EBODDEE, a plurality of DAWs for a decentralized data system based on an optimal distribution strategy for the configurable infrastructure.

13. The method of claim 11, wherein the method further comprises using, via the EBODDEE, differences between read-based and write-based DAWs to optimize usage of available computing capabilities of a given infrastructure.

14. The method of claim 11, wherein the method further comprises scanning, via the EBOIEE, over all possible infrastructure configurations, said scanning over all possible infrastructure configurations enabling the EBODDEE to obtain an optimal infrastructure configuration for the PMF.

15. The method of claim 11, wherein the method further comprises predicting, via the EBODDEE, service level agreement (“SLA”) parameters for different DAW configurations.

16. The method of claim 11, wherein the method further comprises obtaining, via the EBODDEE, a local minimum for entropy variance of the PMF.

17. The method of claim 11, wherein the method further comprises scanning, via the EBOIEE, an infrastructure configuration space to obtain a global minimum for entropy variance of the PMF.

18. The method of claim 11, wherein the method further comprises minimizing, via the EBODDEE, use of network bandwidth for a gossip protocol and maximizing, via the EBODDEE, network bandwidth for actual DAW handling.

19. The method of claim 11, wherein the method further comprises:
providing, via the EBODDEE, an optimal infrastructure for a plurality of infrastructure architectures;
evaluating, via the EBODDEE, using the plurality of infrastructure architectures, the decentralized data systems for budgeting; and
performing, via the EBODDEE, a return on investment (“ROI”) evaluation for:
expenses incurred for a new infrastructure set up; and
benefits obtained from improved service level agreement (“SLA”) parameters.

20. The method of claim 19, wherein the SLA parameters comprise latency and throughput parameters.
